(19) United States
(12) Patent Application Publication
(10) Pub. No.: US 2010/0090148 A1
(43) Pub. Date: Apr. 15, 2010

(54) METHOD FOR THE PRODUCTION OF FLAP MECHANISMS FOR INTAKE LINES OF COMBUSTION ENGINES

(76) Inventors: Siegfried Deiss, Motzing (DE); Peter Fischer, Nittendorf (DE); Georg Mehne, Wenzenbach (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/441,262

(22) PCT Filed: Sep. 12, 2007
(86) PCT No.: PCT/EP2007/059582

§ 371 Date: Dec. 23, 2009

(30) Foreign Application Priority Data
Sep. 15, 2006 (DE) 10 2006 043 342.4

(51) Int. Cl. F16K 1/22; B29C 45/14

(52) U.S. Cl. 251/305; 264/242; 425/542

(57) ABSTRACT

The present invention relates to a method for the production of flap mechanisms in air distribution pipes of combustion engines, wherein the flap mechanisms essentially comprise a frame and a flap rotatably mounted within the frame. To fulfill the demands in regard to the tolerances of the components, the frame and the flap is molded with an injection molding tool out of the same material, such that the flap is placed securely into the frame after the injection molding process. In a further operation, bearings are inserted between frame and bearings.

The present invention relates to a method for the production of flap mechanisms for intake lines of combustion engines, in particular air distribution pipes, wherein the flap mechanisms substantially consist of a frame and a flap rotatably mounted within the frame. The invention relates further to an injection molding tool for carrying out this method as well as a flap mechanism which can be produced by means of the method.

For flap or shut-down mechanisms, respectively, in intake lines or air distributors of combustion engines, respectively, smaller and smaller gap dimensions or a higher and higher tightness, respectively, between the flaps and the pipe channels will be required in the future due to tougher emission legislation. This results in increasing problems to specify the tolerances for the components, in particular with respect to the thermal expansion of the components.

Currently, this problem is solved in that the plastic flaps are slid onto a metal shaft or a metal profile, and thus are quasi-floatingly supported to prevent a seizing of the flaps within the pipe channels due to thermal expansion.

Another solution exists in that flap units are used which consist of a frame and a flap. To implement the smallest gap dimensions between frame and flaps, both parts are injection-molded in one tool, wherein the frame forms a portion of the mold for the flap. To prevent a bonding of the two parts, different materials must be used here. These solutions are primarily in the area of the flap bearings above the necessary temperature range for seizing.

It is the object of the present invention to propose for a method, an injection molding tool, and a flap mechanism, respectively, of the type mentioned above, an improved embodiment which is characterized in particular in that flap mechanisms can be produced inexpensively, which can fulfill all requirements with respect to the tolerance during operation.

This object is solved in that the frame as well as the flap is injection-molded from the same material in an injection molding tool in such a manner that the flap is captively secured within the frame after the injection molding process and that in a further operation, bearings are inserted between frame and bearings.

By means of the method according to the invention, the problem related to the manufacturing tolerances, and hence to the implementation of very small gap dimensions, is solved since the frame as well as the flap is injection-molded in one tool. Unlike the known solutions, both parts are formed by the tool mold, i.e., they are not in contact with one another. The areas of the flap bearings are provided with a clearance which is big enough that an additional bearing between frame and flap can be inserted.

Further advantageous developments of the invention arise from the sub-claims as well as from the description below of a flap mechanism produced according to the method according to the invention and of an injection molding tool for carrying out the method according to the invention by means of the attached drawing.

In the figures:

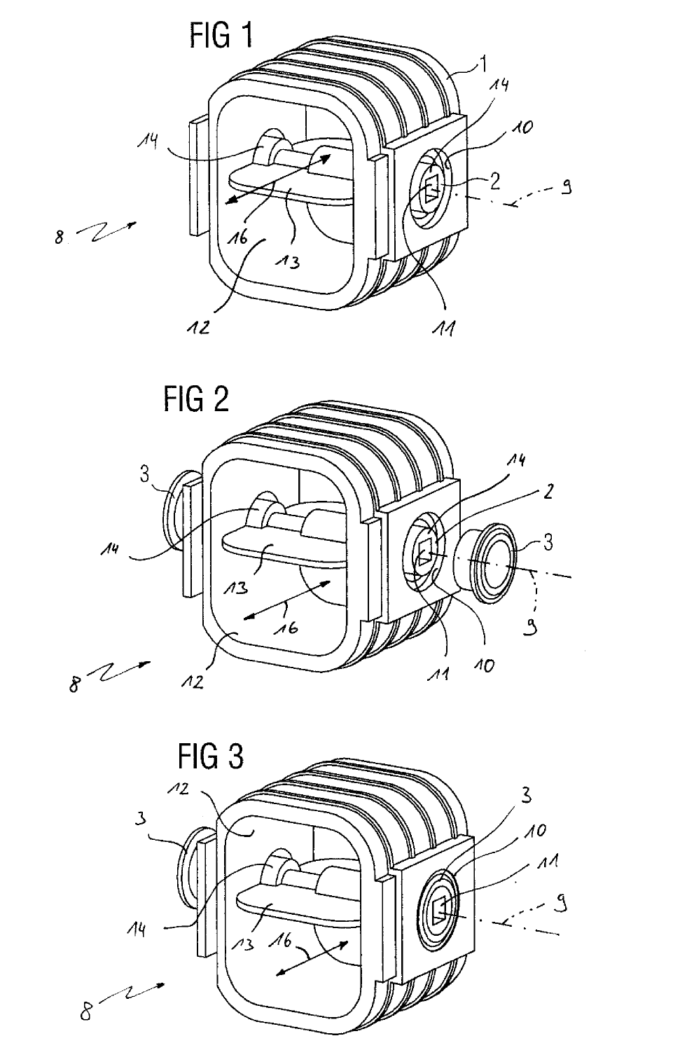

FIG. 1 shows in a perspective view a frame and a flap of a flap mechanism produced according to the method according to the invention,

FIG. 2 shows in a perspective view a frame, a flap, and a bearing, which is not assembled yet, of a flap mechanism according to FIG. 1,

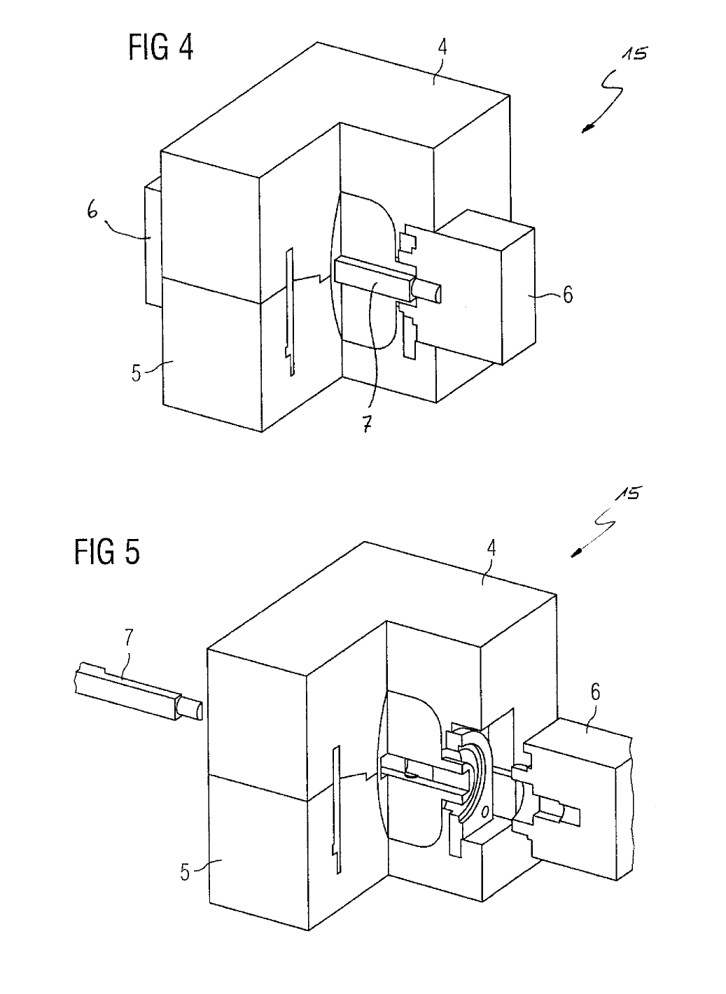

FIG. 3 shows in a perspective view a flap mechanism consisting of frame, flap, and bearings in the assembled condition according to FIG. 1,

FIG. 4 shows a perspective sectional view of an injection molding tool for carrying out the method according to the invention in the closed condition,

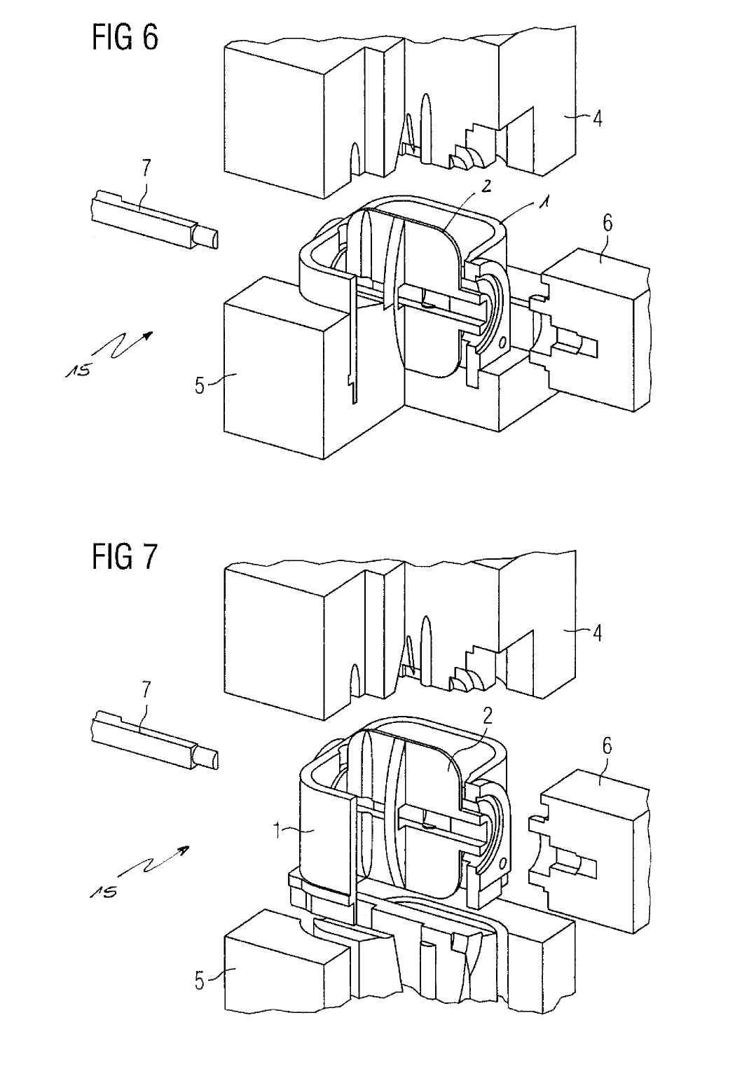

FIG. 5 and FIG. 6 show a perspective sectional view of the injection molding tool shown in FIG. 4 in partially opened conditions, and

FIG. 7 shows in an exploded view the injection molding tool shown in FIG. 4 in the completely opened condition.

FIG. 1 shows a flap mechanism 8 which is suitable for a use in an intake line, e.g., in an air distribution pipe of a combustion engine after the injection molding process according to the present invention. A flap 2 is captively secured within a frame 1. To bring the flap mechanism 8 to a condition ready to use, bearings 3 are inserted according to FIG. 2 between frame 1 and flap 2.

For the captive mounting of the flap 2 within the frame 1, the frame 1 has two openings 10 which are coaxial to a swiveling axis 9 about which the flap 2 can be swiveled in the ready-to-use condition. The two openings 10 are axially opposed with respect to the swiveling axis 9. The flap 2 has centrally a shaft support 11 in which a shaft, which is not shown here, for driving the flap 2 can be inserted to bring the flap mechanism 8 in its ready-to-use condition. The shaft is then arranged coaxial to the swiveling axis 9. Furthermore, the flap 2 has a flap body 13 which is located within an interior space 12 enclosed by the frame 1, and which is adjustable transverse to a flow direction 16 indicated by a double arrow, and by means of which a cross-section of the interior space 12 or the frame 1, respectively, through which a flow can pass, is controllable. In addition, the flap 2 has sections 14 which project axially beyond the flap body 13 with respect to the swiveling axis 9 and which extend axially into the openings 10. The captive locking between flap 2 and frame 1 is formed by the flap's sections 14 which axially extend into the openings 10 of the frame 1. The flap 2 can not be separated from the frame 1 without deformation of the frame 1 and/or the flap 2.

The mentioned openings 10 serve, according to FIG. 2, for receiving the bearings 3.

With the injection molding method, the gap dimension between frame 1 and flap 2 can be individually adjusted. In addition, the bearing arrangement can be adapted depending on the requirements for service life, temperature, and mechanical load.

The FIGS. 4 to 7 show an injection tool 15 for carrying out the method according to the invention in different conditions. The injection molding tool 15 consists substantially of an upper tool part 4 and a lower tool part 5 as well as of the separating inserts 6 and a mold insert 7.

It is apparent from the drawings that the separating inserts 6 each separate, in the front and in the rear, the cavity for the frame 1 from the cavity for the flap 2 during the injection molding process. Frame 1 and flap 2 are preferably injection-molded from plastic and/or are made in particular from the same material.

In the condition according to FIG. 4, the two tool parts 4, 5 are pushed against one another and the separating inserts 6 as well as the mold insert 7 are pushed in. In this condition, the injection molding tool 15 forms the mentioned cavities for the injection molding of the frame 1 and the flap 2. There is a common mold for both components. Remarkable is here that within this common mold, the two separate components, thus frame 1 and flap 2, are separated from one another and hence are injection-molded in particular by means of separate injection channels. The manufacturing of frame 1 and flap 2 can hence be carried out simultaneously, however, in a common injection molding tool 15.

After the injection molding of frame 1 and flap 2, the injection molding tool 15 is opened. For this, according to FIG. 5, first the mold insert 7 and the separating inserts 6 are pulled out while the two tool parts 4 and 5 still remain in the condition pushed against one another. Subsequently, according to FIG. 6, for example, the upper tool part 4 is lifted from the lower tool part 5 so that, according to FIG. 7, the molded parts, hence the frame 1 and the flap 2 captively arranged therein, can be removed from the lower tool part 5.

1-6. (canceled)

7. A method for the production of flap mechanisms comprising the steps of:
mounting a flap rotatably within a frame;
placing the flap and frame into a molding tool;
molding the frame and flap, wherein the flap is captively secured within the frame; and
inserting bearings between the frame and flap.

8. The method according to claim 7, wherein the frame and the flap are injection-molded from at least one of a same plastic material and different plastic materials.

9. An injection molding tool comprising:
a first tool top part;
a second tool bottom part, wherein the first tool part and the second tool part are positioned on top of each other to form at least one cavity for the frame and at least one cavity for the flap, wherein the cavities form a front and a back of a flap mechanism;
the flap mechanism includes a flap rotatably mounted within a frame;
at least one separating insert positioned within the cavities and onto the two tool parts, wherein the separating inserts separate the two cavities from one another and provide a space for inserting at least one bearing between the frame and the flap.

10. The injection molding tool according to claim 9, wherein a gap dimension between frame and flap is individually adjustable.

11. The intake line flap mechanism according to claim 9, wherein the two bearings are inserted between the frame and the flap.

12. An intake line flap mechanism comprising:
a frame, and
a flap, wherein the flap is rotatably mounted and is captively secured within the frame.

13. The intake line flap mechanism according to claim 12, where the frame and the flap are injection molded parts.

14. The intake line flap mechanism according to claim 12, wherein the flap is supported by at least one bearing which is inserted from the outside between the frame and the flap.

15. The intake line flap mechanism according to claim 12, wherein the flap is supported by two bearings which are inserted from the outside between the frame and the flap.
